(19) United States
(12) Patent Application Publication
(10) Pub. No.: US 2025/0229423 A1
(43) Pub. Date: Jul. 17, 2025

(54) Method and System for Identifying Hazards in a Robot Application

(71) Applicant: ABB Schweiz AG, Baden (CH)

(72) Inventors: Fan Dai, Zwingenberg (DE); Silke Klose, Bensheim (DE); Björn Matthias, Bad Schönborn (DE); René Kirsten, Fernwald (DE); Debora Clever, Zwingenberg (DE); Florian Stuhlenmiller, Ladenburg (DE); Christoph Byner, Mannheim (DE)

(73) Assignee: ABB Schweiz AG, Baden (CH)

(21) Appl. No.: 19/095,343

(22) Filed: Mar. 31, 2025

Related U.S. Application Data
(63) Continuation of application No. PCT/EP2022/077423, filed on Oct. 2, 2022.

(51) Int. Cl. B25J 9/16

(52) U.S. Cl. CPC B25J 9/1676; B25J 9/163

(57) ABSTRACT

A method for identifying hazards in a robot application comprises a) providing a model of an application environment of a robot, the application environment extending beyond the limits of a movement range of the robot, the movement range comprising all points that the robot can occupy in any pose it is capable of assuming; b) identifying at least one point in the environment suitable for supporting a person; c) for each point identified in step b), defining a safety space above the point, the safety space comprising a volume expected to be occupied by a person supported by the point and a safety range around the volume; d) identifying one of the at least one point identified in step b) as hazardous when the safety space associated to said point overlaps with the movement range of the robot.

### CROSS-REFERENCE TO RELATED APPLICATIONS

The instant application claims priority to International Patent Application No. PCT/EP2022/077423, filed Oct. 2, 2022, which is incorporated herein in its entirety by reference.

### FIELD OF THE DISCLOSURE

The present disclosure generally relates to a method for identifying hazards in a robot application and to an application development system in which the method can be carried out.

### BACKGROUND OF THE INVENTION

In an application environment where human staff and robots share a same workspace, ensuring that staff cannot be injured by movement of a robot is a key issue, which makes up for a substantial portion of application development cost. In order to facilitate this task, U.S. Pat. No. 9,430,589 B2 proposes a development systems in which an image of the environment and of the robot moving in this environment are displayed. Based on images displayed to him, a developer can judge whether a given type of hazard is associated to a given access point, and when a hazard is identified, the system assists the developer in choosing an appropriate safety device. Identification of potentially hazardous situations still depends on the experience and meticulousness of the developer.

### BRIEF SUMMARY OF THE INVENTION

The embodiments in accordance with the disclosure generally assist in identifying critical situations. According to a first aspect of the invention, this object is achieved by a method for identifying hazards in a robot application comprising the steps of: a) providing a model of an application environment of a robot, the application environment extending beyond the limits of a movement range of the robot, the movement range comprising all points which the robot can occupy in any pose it is capable of assuming; b) identifying at least one point in said environment suitable for supporting a person; c) for each point identified in step b), defining a safety space above said point, the safety space comprising a volume expected to be occupied by a person supported by said point and a safety range around said volume; d) identifying one of the points identified in step b) as hazardous if the safety space associated to said point overlaps with the movement range of the robot.

The model of the application environment will typically at least comprise data describing the dimensions and mobility characteristics of the robot, i.e., data based on which it is possible to decide, for any point in the application environment, whether the robot is capable of occupying this point or not, as well as data on the shape of stationary objects such as tabletops, partition walls, or on the shape of objects which, in spite of being mobile, occupy a fixed region in space, such as a conveyor. It may also comprise data on one or more moving objects such as further robots and on how these cooperate with the first-mentioned robot.

In order to limit the number of points to be examined to a practical value, it is useful to define a lattice extending over the application environment, in which each unit cell of the lattice can be assigned a reference point indicative of its position, and to examine only the reference points. The size of the cells should not be larger than a person's foot.

The lattice can be two-or three-dimensional. In case of a three-dimensional lattice, the reference point is in three dimensions, i.e., its position in space is unequivocally determined, and based on this position, a decision whether it is suitable for supporting a person can be taken. In case of a two-dimensional lattice, reference points are defined in two dimensions only, and a reference point in three dimensions is obtained by associating to each reference point in two dimensions a third coordinate of a surface point above or below the reference point in two dimensions. The third coordinate can be obtained using information from the model.

In the three-dimensional case, such a reference point may be close to a surface on which a person might tread, but the probability of the reference point actually being located on that surface is infinitesimal. Therefore, the reference point can be regarded as suitable for supporting a person when there is a surface for treading on within the unit cell associated to the reference point. A necessary condition for the existence of such a surface is that the unit cell is part of or overlaps with an immobile object, since without an immobile object there would be nothing in the unit cell that might carry a person. A stricter condition is that the unit cell comprises part of a surface of an immobile object, since if the unit cell is part of an immobile object, but there is no surface of that object within the unit cell, a person's foot wouldn't be able to reach it but would find support in some other unit cell above. Further, the surface should be part of an upper surface of the immobile object, or, as a still narrower criteria, the upper surface of the immobile object should be substantially horizontal, i.e. its slope, if any, should be small enough to prevent a person's foot from sliding.

When, as mentioned above, reference points are chosen on a floor surface only, the above criteria will be satisfied automatically. However, checking whether the surface in question is already occupied by another object and therefore inaccessible to a person's foot, or whether the surface is large enough to accommodate a person's foot makes sense in both cases.

Further, in both cases, a point may be regarded as suitable for supporting a person only if there is a way for a person to reach it, i.e. if the environment has at least one access point where a person can enter the environment, and if there is a path from the entry point to the reference point (or, which amounts to the same thing, to the unit cell associated to the reference point).

Such a path can be deemed not to exist if the distance between said reference point (or its unit cell) and a further reference point suitable for supporting a person is larger than a person's step length.

In the simplest case, unit cells are squares (in case of a two-dimensional lattice), cubes or cuboids (in case of a three-dimensional lattice).

In order to facilitate evaluation of the results of the method of the invention by a developer, the method should comprise further steps of e) displaying an image of the model of the application environment, and f) highlighting in said displayed image all points identified as hazardous in step d).

If a point has been identified as hazardous in step d), possible measures comprise g) making a change to the model by which the identified point becomes unsuitable for supporting a person and/or h) reducing the movement range of the robot so as to remove or reduce the overlap.

An identified point can be made unsuitable for supporting a person by removing the immobile object, or by changing its shape so that it won't provide a foothold any longer. Alternatively, a path between the identified point and an access point can be blocked, e.g. by cancelling the access point in question or by introducing a wall or some other kind of impassable obstacle between the access point and the identified point.

While geometric considerations necessary for making a point unsuitable for supporting a person or for reducing the movement range of the robot are fairly easy to implement in software, checks for the compatibility of such measures with the overall objective of a specific application aren't. Therefore, the above step g) of making a change preferably comprises proposing a change to a developer or some other human supervisor, and carrying out the change to the model upon approval by the supervisor only. Analogously, step h) preferably comprises proposing a reduction of the movement range to the supervisor and carrying out the reduction upon approval by the supervisor.

Proposing a change of the model can be carried out by displaying an image of the model with the change applied to it. Analogously, a reduction of the movement range can be proposed by displaying an image of the reduced movement range.

The object of the invention is further achieved by a robot application development system comprising a storage for storing a model of an application environment of a robot, a processor for applying the above-described method to the model and a user interface for outputting at least each point identified as hazardous.

As is apparent from what has been said above, the user interface should be adapted to display an image of the model, and/or to output a change to the model proposed by the processor and to accept a supervisor's approval or disapproval of the proposed change.

The object of the invention is also achieved by a computer program product comprising instructions which, when executed by a processor, cause the processor to carry out the above-described method, and by a computer-readable storage medium having stored thereon such instructions.

Further features and advantages of the invention will become apparent from the subsequent description of embodiments, referring to the appended drawings.

### BRIEF DESCRIPTION OF THE SEVERAL VIEWS OF THE DRAWING(S)

FIG. 1 is a plan view of an application environment of a robot to which the method of the invention is applied in accordance with the disclosure.

FIG. 2 is a plan view of a section of the application environment taken along line II-II of FIG. 1.

FIG. 3 is a plan view of the application environment, the results of a hazard judgment by the application development system in accordance with the disclosure.

FIG. 4 is a plan view of the application environment, a proposal by the application development system how to improve safety for a person in accordance with the disclosure.

FIG. 5 is a plan view of the application environment, a further proposal by the application development system in accordance with the disclosure.

FIG. 6 is a plan view of a revised version of the application environment in accordance with the disclosure.

### DETAILED DESCRIPTION OF THE INVENTION

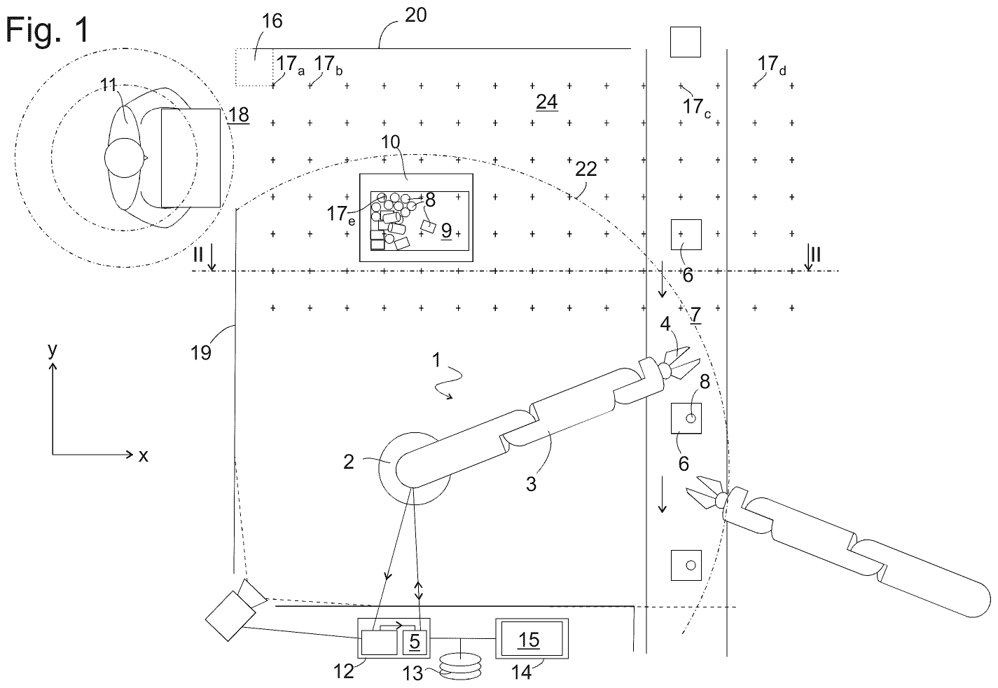

FIG. 1 is a schematic plan view of an industrial robot 1 and its working

environment. In the embodiment shown here, the robot 1 has a stationary base 2, at least one articulated arm 3 and an end effector 4 at the free end of the arm 3, but it should be kept in mind that the method which will be described subsequently is also applicable to other types of robots, such as a gantry type robot, mobile robots etc.

The motion of the robot 1 is controlled by a an operation controller 5, typically a microcomputer, in order to carry out a manufacturing task, for example combining each of a series of first workpieces 6, supplied by a conveyor 7, with a second workpiece 8, taken from a crate 9 on a table 10. While the robot 1 is carrying out this task, the safety of a person 11 has to be ensured, who may be replacing the crate 9 when empty or who may be just passing by, unanticipated by the operation controller 5, to carry out some other job.

An application development system may be implemented on a same computer hardware with operation controller 5, or physically separate from it and the robot 1. In the example of FIG. 1, it is assumed that the operation controller 5 and the application development system are implemented on the same microcomputer 12, and that the microcomputer 12 is connected to storage 13 in which a model of the working environment is stored, and to a user interface 14. The user interface 14 comprises a screen 15 for outputting an image of the working environment derived from the stored model, so that on that screen 15, FIG. 1 could be displayed.

The working environment as displayed on the screen 15 comprises a piece of workshop floor 24, extending in x and y directions, on which the robot 1 and other equipment is mounted, and which is subdivided by the application development system into two-dimensional cells 16 that cover the entire floor surface. In the simplest case, and as shown in FIG. 1, all cells 16 are identical in shape and size, preferably rectangles or squares, and form a regular lattice of lines and columns, but a polar arrangement in which cells are delimited e.g. by clockwise and anticlockwise spirals having e.g. the base 2 for origin could also be used. Each cell 16 is assigned a reference point 17 which can be its center of gravity or some other conveniently defined point of the cell 16. In the example of FIG. 1, for the sake of convenience, the reference point 17 is at the lower right corner of each cell 16.

For each reference point 17, the application development system determines whether it would be suitable to support a foot of the person 11. As a first example, consider reference point 17ₐ, in the upper left corner of the working environment, close to a door or a passage 18 formed between walls 19, 20 delimiting the working environment and by which the person 11 can access the working environment. The cell associated to reference point 17ₐ evidently comprises part of an upper surface of an immobile object, namely of the workshop floor 24 itself, so the elevation of the workshop can be associated as a z coordinate to x and y coordinates of the point 17_{a.} While the cell associated to reference point 17ₐ alone will be too small to accommodate a foot, examination of adjacent cells will show that it can be combined with adjacent cells to provide a flat surface large enough to place a foot upon. Since the cell 16 of reference point 17ₐ is further directly adjacent to the passage 18, it is also physically possible for the person 10 to reach this cell 16. Therefore, reference point 17ₐ (or its associated unit cell 16) is found suitable for supporting the person 10.

Now consider adjacent reference point 17_{b.} Since it belongs to one of the adjacent unit cells examined in the procedure for reference point 17ₐ described above, it must also be part of a flat surface large enough for a foot, and, being adjacent to accessible point 17ₐ, it can be concluded that it is accessible, too. It is thus readily apparent that one after the other, reference points in the same horizontal line as points 17ₐ and 17_{b} will be found suitable, until the procedure reaches point 17_{c.} Here the application development system finds that a surface at this point is part of conveyor 7 and has a z coordinate higher than that of the workshop floor 24. For obvious reasons this surface should not be stepped upon. This is ensured by the model identifying the conveyor 7 as a mobile object. Reference point 17_{c} is thus identified as unsuitable for supporting a person since the object 7 to whose surface it belongs is not immobile.

On the other side of the conveyor 7, reference point 17ₐ is part of the workshop floor 24 again, and there is enough flat workshop floor surface around it to accommodate a person's foot. However, between it and all other reference points to the left of point 17_{c} that meet the criteria, there is the conveyor 7. The application development system judges by the height and width of the conveyor 7 whether it is possible for the person 11 to step across, and, if the conveyor 7 is too big, i.e. if the distance between point 17ₐ and the closest suitable reference point on the other side of the conveyor 7 exceeds a threshold that may depend on the height of the conveyor, finds point 17ₐ unsuitable to support a person.

Reference point 17ₑ is identified as lying on table 10. Since the model identifies the table 10 as an immobile object, and point 17ₑ is part of a horizontal surface, it might thus qualify as suitable. However, since adjacent reference points such as 17_{f} are identified as lying inside the crate 9, and since neither the crate 9 nor the workpieces 8 in it are immobile, reference point 17_{f} is found unsuitable for supporting a person, and so is point 17ₑ, since the flat surface of which it is part is too small to support a foot. Alternatively, point 17ₑ might be found unsuitable because the difference in z coordinates between it and adjacent suitable points is too large for a person to climb.

As a further alternative, there might be a workplace policy which prohibits stepping on or across a conveyor or any other equipment on the workshop floor; in that case, the point 17ₐ would be judged not to be accessible from passage 18 and, hence, in the absence of other ways of access, unsuitable for supporting a person, due to the presence of the conveyor 7 regardless of its height and width, and point 17ₑ would be ruled out as unsuitable since the policy rules that people shall not climb on tables.

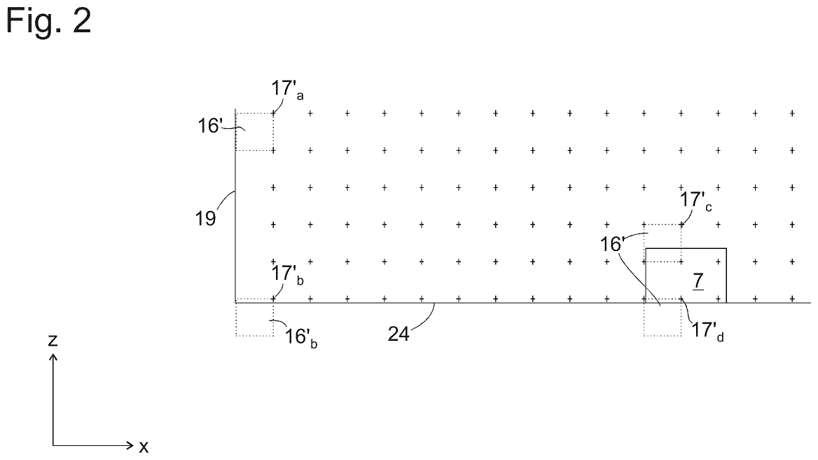

According to an alternative approach, reference points suitable for supporting a person can be determined by defining a three-dimensional lattice of unit cells, each of which is identified by a reference point in three dimensions, e.g. having three Cartesian coordinates. FIG. 2 shows a section of the application environment taken along line II-II, in x and z directions, of FIG. 1. In this section, reference points 17′ and unit cells 16′ of such a three-dimensional lattice are shown. Based on the model of the application environment, the application development system determines for each reference point whether its unit cell 16′ is part of or overlaps with an immobile object. For reference point 17′a and some other points below it, the answer is clearly no; their cells contain air only. The unit cell 16′_{b} of reference point 17′_{b} is the first in this column of points to contain a portion of rigid object surface, namely of the workshop floor 24. It can further be ascertained that there is enough rigid surface around that portion to accommodate a foot, that the surface is horizontal or, at least, that its slope is small enough for the foot not to slide, and that, since an adjacent surface portion is accessible from passage 18, the surface portion associated to reference point 17′_{b} must be accessible, too. So the application development system concludes that reference point 17′_{b} is suitable for supporting a person.

This procedure is repeated for other reference points until reference point 17′_{c} is reached, whose unit cell is found to comprise a surface portion of the conveyor. The surface portion is horizontal and may even be large enough to accommodate a foot, but is found unsuitable because it is not immobile. Underneath, there is another reference point 17′_{d} whose unit cell comprises part of the workshop floor, but it can also be ruled out as unsuitable because the distance to another surface portion above it, i.e. the upper surface of the conveyor 7, is less than the height of a person.

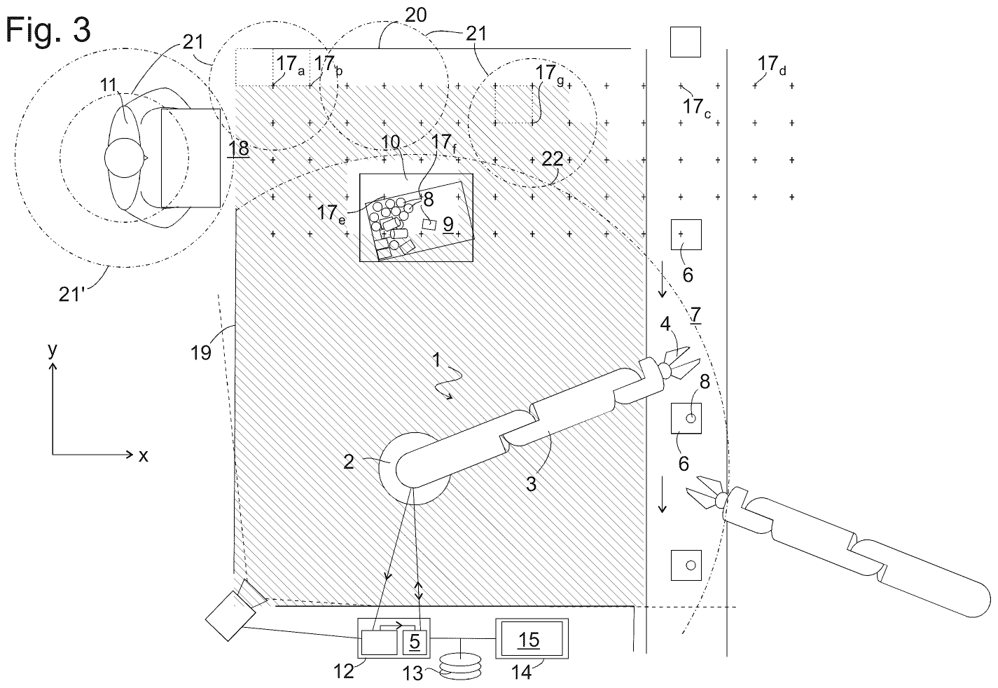

Among the reference points identified as suitable for supporting a person, in a next step, the application development system identifies those where a person present there could actually be hit by the robot 1. This can obviously happen not only when the robot 1 is capable of reaching the reference point itself but any body part of a person 11 standing on the reference point. Therefore, as shown in FIG. 3, the application development system defines a cylindrical safety space 21 in which the person 11 can be expected to fit when standing upright or walking normally, i.e., whose height is that of the person 11 and whose diameter is slightly larger than the width of the person's shoulders, and checks, for each reference point 17 that is found suitable for supporting a person, whether, when the base of the cylindrical volume 16 is centered upon said reference point, there is an overlap between this safety space 21 and a movement range 22 of the robot 1.

The dimensions of the safety space 21 may vary depending on what the person 11 is doing. When the person is carrying a replacement crate, as shown in FIG. 3, it may be necessary to define a safety space 21′ having a larger diameter in order to accommodate arms of the person 11 extending away from the torso.

As can be seen in FIG. 3, safety space 21 can be centered upon reference point 17ₐ without overlapping with range 22; therefore a person located at reference point 17ₐ is in no danger of being struck by the robot 1. The same is true for point 17, and all other points along the same horizontal line, so that the person 11 could reach the conveyor 7 by moving in the cells 16 of this line without danger of being hit by the robot 1. For points of the next line, such as 17_{g}, there is an overlap between their respective safety spaces 21 and the range 22, so that the application development system identifies these points as hazardous for a person.

When such an assessment has been carried out for all reference points that have been found suitable to support a person, the application development system displays on screen 15 a map of the application environment, in which those reference points that are suitable for supporting a person but hazardous or their respective unit cells are highlighted as illustrated by hatching in FIG. 3.

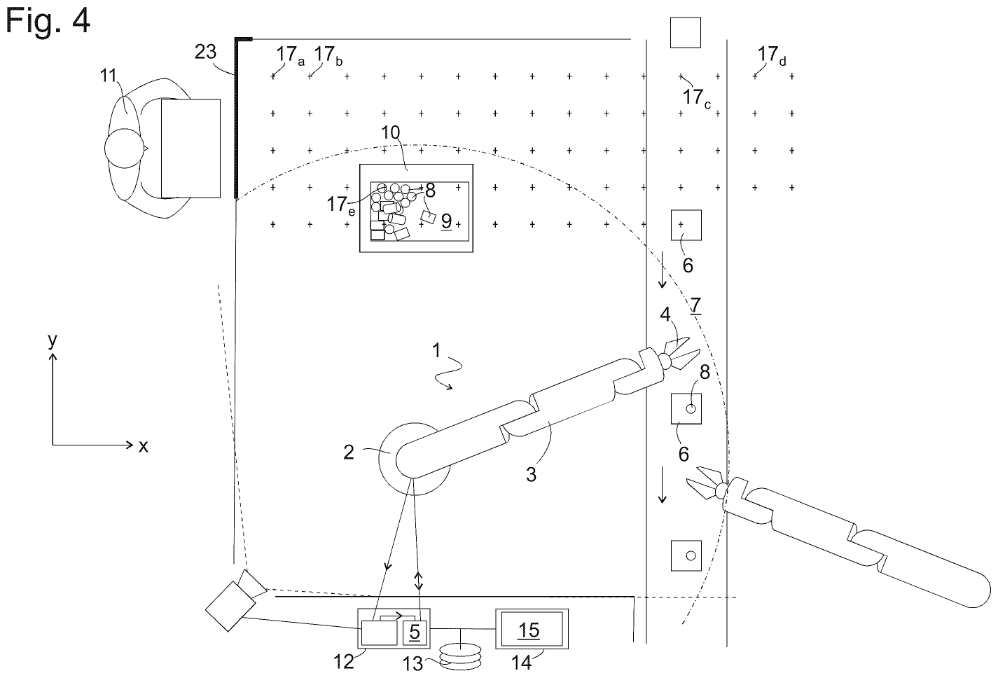

From the map of FIG. 3 it is apparent that when walking through passage 18, the person 11 is likely to directly enter a hazardous area, which must be avoided. Depending on the information available to it at this stage, the application development system can propose countermeasures. If there is no information available to the application development system why the presence of a person in the environment should be necessary, a readily apparent remedy would be to block passage 18 by broadening wall 19. As illustrated in FIG. 4, such a proposal might be submitted to a supervisor by displaying an additional wall portion 23 blocking passage 18 on screen 15. IN FIG. 4, there is no hatching any more, since the entire workshop floor 24 has become unsuitable to support a person by blocking access to it. The supervisor, aware of the need to reach table 10 and replace the crate 9 on it, will reject such a proposal.

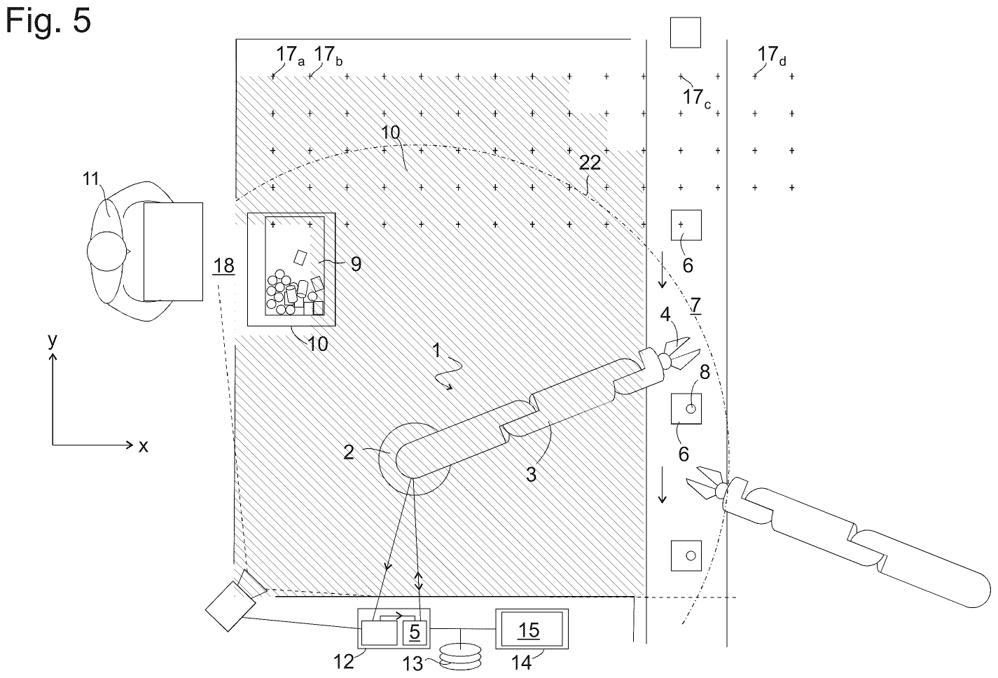

When the application development system is aware of the necessity to replace the crates, it will not propose to block access, instead it might suggest to displace the passage 18 and place the table 10 immediately behind, as shown in FIG. 5, so that the person 11 would not have to enter the environment, but could just reach through the passage 18 and replace the crate. The supervisor may accept the proposal, or he may reject it since the robot would have to move far between the crate 9 and the conveyor 7 and productivity would be decreased.

A further proposal by the application development system might then be to introduce a further wall portion 25 between the passage 18 and the robot 1, which would slightly reduce the range 22 available to the robot, but would provide behind it a safe space for the person 11 to move in and to reach the table 10. The supervisor may find this proposal suitable and accept it.

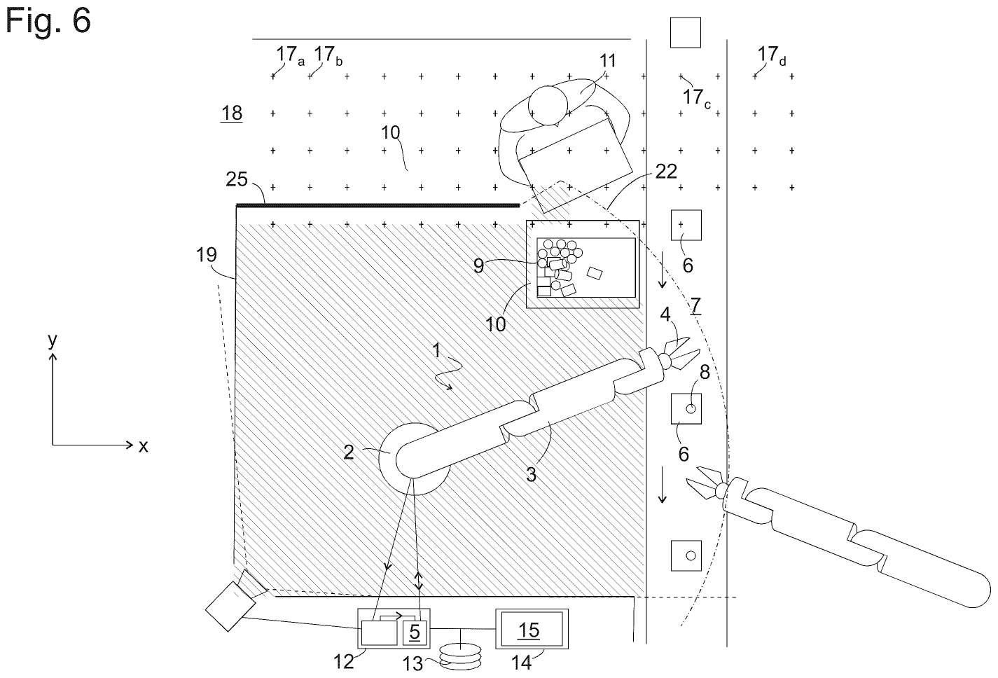

He may further amend the model, e.g. by pointing at the table 10 on screen 15, e. g. using a mouse, and dragging it to a position next to the conveyor 7; realizing that this would allow to shorten the movement of the robot 1 and thus improve productivity, and have the application development system adapt the length of the wall portion 25, thereby obtaining the model shown in FIG. 6.

The application development system may further be adapted to propose the introduction of safety equipment, e. g. of a camera or some other kind of sensor appropriate for detecting if (and, preferably, where) a person is located in the application environment, and for causing the operation controller 5 to at least temporarily stop movement of the robot 1 when the safety space of the person overlaps range 22 of the robot.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

robot
base
arm
end effector
operation controller
first workpiece
conveyor
second workpiece
crate
table
person
microcomputer
storage
user interface
screen
tile
reference point
passage
wall
wall
safety space
range
wall portion
workshop floor
wall portion

What is claimed is:

1. A method for identifying hazards in a robot application, comprising:
a) providing a model of an application environment of a robot, the application environment extending beyond the limits of a movement range of the robot, the movement range comprising all points which the robot can occupy in any pose it is capable of assuming;
b) identifying at least one point in the environment suitable for supporting a person;
c) for each point identified in step b), defining a safety space above the point, the safety space comprising a volume expected to be occupied by a person supported by the point and a safety range around the volume;
d) identifying one of the at least one point identified in step b) as hazardous when the safety space associated to the point overlaps with the movement range of the robot.

2. The method of claim 1, wherein step b) comprises:
b1) defining a three-dimensional lattice extending over the environment, wherein each cell of the lattice contains a reference point in three dimensions, or defining a two-dimensional lattice extending over a floor surface of the application environment, wherein each cell of the lattice contains a reference point in two dimensions, and obtaining a reference point in three dimensions by associating to each reference point in two dimensions a third coordinate of a surface point above or below the reference point in two dimensions;
b2) for each reference point in three dimensions, deciding whether it is suitable for supporting a person.

3. The method of claim 2, wherein a reference point is found to be suitable for supporting a person when it fulfills one or more of the following criteria:
its lattice cell is part of or overlaps with an immobile object;
its lattice cell comprises part of a surface of an immobile object;
its lattice cell comprises part of an upper surface of an immobile object;
its lattice cell comprises part of a substantially horizontal upper surface of an immobile object;
its lattice cell comprises part of a surface that is large enough to accommodate a human foot;
the environment has at least one access point where a person can enter the environment, and there is a path from the access point to the lattice cell;
the distance between the lattice cell and a further lattice cell whose reference point is suitable for supporting a person is equal to or less than a step length.

4. The method of claim 2, wherein the lattice cells are squares, cubes or cuboids.

5. The method of claim 1, further comprising the steps of:
e) displaying an image of the model of the application environment, and
f) highlighting in the displayed image all points identified as hazardous in step d).

6. The method of claim 1, further comprising, when a point has been identified as hazardous in step d), the step of:
g) making a change to the model by which the identified point becomes unsuitable for supporting a person;
and/or
h) reducing the movement range of the robot so as to remove or reduce the overlap.

7. The method of claim 6, wherein the identified point is made unsuitable by removing or changing the shape of the immobile object or by blocking a path between the identified point and an access point.

8. The method of claim 6, wherein step g) comprises proposing a change to a supervisor and carrying out the change to the mod-el upon approval by the supervisor, and/or step h) comprises proposing a reduction of the movement range to the supervisor and carrying out the reduction upon approval by the supervisor.

9. The method of claim 8, wherein proposing a change is carried out by displaying an image of the model with the change applied to it, and/or proposing a reduction of the movement range is carried out by displaying an image of the reduced movement range.

10. A robot application development system comprising:
a storage for storing a model of an application environment of a robot,
a processor for applying a method for identifying hazards in a robot application, the method comprising:
a) providing a model of an application environment of a robot, the application environment extending beyond the limits of a movement range of the robot, the movement range comprising all points which the robot can occupy in any pose it is capable of assuming;
b) identifying at least one point in the environment suitable for supporting a person;
c) for each point identified in step b), defining a safety space above the point, the safety space comprising a volume expected to be occupied by a person supported by the point and a safety range around the volume;
d) identifying one of the at least one point identified in step b) as hazardous when the safety space associated to the point overlaps with the movement range of the robot; and
a user interface for outputting at least each point identified as hazardous.

11. The robot application development system of claim 10, wherein the user interface is adapted to display an image of the model.

12. The robot application development system of claim 10, wherein the user interface is adapted to output a change to the model proposed by the processor and to accept a supervisor approval or disapproval of the proposed change.

13. A tangible computer-readable storage medium having stored thereon instructions which, when executed by a processor, cause the processor to carry out a method for identifying hazards in a robot application, the method comprising:
a) providing a model of an application environment of a robot, the application environment extending beyond the limits of a movement range of the robot, the movement range comprising all points which the robot can occupy in any pose it is capable of assuming;
b) identifying at least one point in the environment suitable for supporting a person;
c) for each point identified in step b), defining a safety space above the point, the safety space comprising a volume expected to be occupied by a person supported by the point and a safety range around the volume;
d) identifying one of the at least one point identified in step b) as hazardous when the safety space associated to the point overlaps with the movement range of the robot.
